(19) United States
(12) Patent Application Publication
(10) Pub. No.: US 2011/0264913 A1
(43) Pub. Date: Oct. 27, 2011

(54) METHOD AND APPARATUS FOR INTERWORKING WITH SINGLE SIGN-ON AUTHENTICATION ARCHITECTURE

(76) Inventors: Pekka NIKANDER, Jorvas (FI); Patrick EKDAHL, Dalby (SE); Vesa LEHTOVIRTA, Espoo (FI); Karl NORRMAN, Stockholm (SE); Monica WIFVESSON, Lund (SE)

(21) Appl. No.: 13/074,299

(22) Filed: Mar. 29, 2011

Related U.S. Application Data
(63) Continuation of application No. PCT/EP2011/054303, filed on Mar. 22, 2011.
(60) Provisional application No. 61/323,457, filed on Apr. 13, 2010.

(51) Int. Cl. H04L 9/32; G06F 15/16; G06F 21/00

(52) U.S. Cl. 713/168; 726/8

(57) ABSTRACT

A method is provided for use in interworking a single sign-on authentication architecture and a further authentication architecture in a split terminal scenario. The split terminal scenario is one in which authentication under the single sign-on authentication architecture is required of a browsing agent (8) being used to access a relying party and in response, due to the interworking in the split terminal scenario, an associated authentication under the further authentication architecture is performed in relation to a separate authentication agent (7). A controlling agent (4) sends (C3) a token to the authentication agent (7). The controlling agent (4) sends (C4) a request to the browsing agent (8) to return a token for comparing with the token sent to the authentication agent (7). The controlling agent (4) waits (06) for the authentication agent (7) or a user of the authentication agent (7) to communicate (A2) the received token to the browsing agent (8) via a secure and/or trusted channel and for the browsing agent (8), in response to the earlier received request, to forward (B4) the token to the controlling agent (4). The controlling agent (4) receives (C7) the token from the browsing agent (8). The controlling agent (4) compares (C10) the received token with the token sent to the authentication agent (7) to determine whether the authentication agent (7) is authorised to perform authentication on behalf of the browsing agent (8) and/or whether the browsing agent (8) is authorised to act as a representative for the authentication agent (7). The controlling agent (4) authenticates (C11) the browsing agent (8) to the relying party based on the associated authentication performed in relation to the authentication agent (7) if it is determined in the comparing step (C10) that the authentication agent (7) and/or browsing agent (8) is so authorised.

### TECHNICAL FIELD

The present invention relates to a method and apparatus for use in interworking a single sign-on authentication architecture and a further authentication architecture in a split terminal scenario. In particular, but not exclusively, the present invention relates to a method and apparatus for use in interworking an OpenID authentication architecture and a 3GPP authentication architecture.

### BACKGROUND

The 3GPP specified Generic Bootstrapping Architecture (GBA) is described in 3GPP TS 33.220: “Generic Authentication Architecture (GM); Generic Bootstrapping Architecture”, which document will be referred to herein in brief as [33220]. GBA is a mechanism to use 3G Authentication and Key Agreement algorithm to access application layer services. GBA is used by many services, including MBMS (Multimedia Broadcast Multicast Service), Enhanced MBMS, Access Network Discovery and Service Function (ANDSF), Open Mobile Alliance (OMA) XML Document Management, Presence Security, etc. GBA can use USIM (Universal SIM) with GBA_U aware UICC application (GBA_U is GBA using GBA aware UICC, where UICC is a Universal Integrated Circuit Card or “SIM”), ISIM, or 2G SIM.

OpenID (derived from “Open Identity”) is an open, decentralized standard for authenticating users, and is specified in “OpenID Authentication 2.0” by the OpenID Foundation, http://openid.net/ (the OpenID standard is referred to herein as [OpenID] for brevity). It can be used for access control, allowing users to log on to different Internet services with the same digital identity, as long as these services trust the authenticating party. OpenID is intended to replace the common log-on process based on a (dedicated) login-name and related password for each specific internet service, allowing a user to login once and gain access to the resources of multiple Internet-based services.

3GPP is working on a technical report, TR 33.924 (“Identity management and 3GPP security interworking; Identity management and Generic Authentication Architecture (GAA) interworking”) that will define how GBA and Open ID should interwork. TR 33.924 will specify how GBA can be used as the authentication method in OpenID framework. The 3GPP TR 33.924 draft of April 2009 is referred to herein as [33924] for brevity.

The architecture or TR 33.924 interworking is depicted in FIG. 1 of the accompanying drawings. In FIG. 1, a user equipment (UE) is connected to both OpenID and GBA nodes. The straightforward approach to combine the GBA and the OpenID Architectures is to co-locate the Network Application Function (NAF) functionality with the OP (OpenID Provider) in a single node, the NAF/OP (or OP/NAF). Accordingly, FIG. 1 shows a Subscriber Location Function (SLF) 1, a Bootstrapping Server Function (BSF) 2, a Home Subscriber Server 3, the NAF/OP (or OP/NAF) 4, a Relying Party (RP) 5, and the UE 6. Interworking basically operates as follows. The UE 6 accesses a website or other service at the RP 5 (the RP 5 could be one of many using the same OP/NAF 4). The RP 5 needs to authenticate the UE using the OpenID method, and presents e.g. a request for a user name to the UE. The RP 5 then hands over to the OP/NAF 4 to perform the actual authentication (with an option secure channel between the OP/NAF 4 and the RP 5). The OP/NAF 4 then makes use of GBA to help authenticate the user. Once authenticated, a confirmation of this is sent back to the RP 5. In FIG. 1 there can be considered to be a vertical dividing line between the NAF and the OP, with what is to the left of the dividing line deriving from GBA, and what is to the right of the dividing line deriving from OpenID.

TR 33.924 also describes a so-called “split terminal scenario”, where a web browser and the entity being authenticated by the network do not reside in the same physical instance, as is the case in the basic scenario. In the split terminal scenario, as is illustrated in FIG. 2 of the accompanying drawings, the former UE 6 is divided into a

Browsing Agent (BA) 8, which for example may reside in a personal computer, and an Authenticating Agent (AA) 7, which resides in a device that has direct access to a SIM, for example a mobile phone (or UE).

The split terminal scenario is currently in [33924] described in terms of three scenarios (or sub-scenarios), where scenario 1 uses GBA push (see 3GPP TS 33.223, Generic Authentication Architecture (GAA); Generic Bootstrapping Architecture (GBA) Push function), where scenario 2 uses some other, unspecified push message (e.g. SMS) to trigger the AA to initiate a GBA run, and where in scenario 3 a local link (e.g. BlueTooth, physical cable) is used between the AA and BA to trigger a normal GBA run.

Scenario 1 is described in [33924] as being based on using GBA push and relying on a user to compare two pieces of presumably identical session ID. FIG. 4.4.2-4 from [33924] shows the signaling flow for scenario 1 and is replicated here for the benefit of the reader as FIG. 3 of the accompanying drawings.

In step 4 of FIG. 3, the BA 8 is redirected (using HTTP redirect) from the Open ID RP (Relying Party) to the OP/NAF 4 (a collocation of OP and NAF), for authentication. In step 6, the OP/NAF 4 replies to the BA 8 with an HTTP response including a session ID. The OP/NAF 4 also sends the same session ID to the AA 7 within a GBA Push message (step 8). The purpose of the session ID is that the AA 7 and the BA 8 sessions have to be mapped by the user and the user has to give consent to continue with GBA push network authentication and key agreement.

The present applicant has appreciated that this arrangement introduces at least the following problems:

Firstly, the session ID is not protected when sent from the OP/NAF to the AA. This means that an attacker could see and/or modify the session ID in transit and possibly trick the user to allow to run GBA push network authentication for a service of attacker's choice.

Secondly, the session ID is compared by the user. In other words, it is left to the user's responsibility to ensure that the GBA network authentication is performed for the claimed service. However, this introduces added risk as experience has shown that users can be lazy or careless in making such a comparison, especially if the required action is to simply press a “yes” or a “no”. A user may well be tempted to press “yes” without making a careful comparison. Users often do not understand the purpose, importance or implications of pressing “yes”, and press “yes” just to gain access to the service (which is their main goal).

Thirdly, making such comparisons is not commonplace today. According to the practices used today, the users are typically requested to copy or write a piece of text from one place to another.

Fourthly, proof of correctly processing the GBA Push message (more precisely GPI, which is an abbreviation of GBA Push Info) has not been defined in step 11. It needs to be specified in order to ensure interoperability.

Finally, the use of HTTP requests and responses is not in line with the de-facto usage of HTTP. More specifically, in step 12 of Scenario 1(and the corresponding Step 14 of Scenarios 2 and 3), an HTTP redirect seems to be a response to a HTTP request received in the previous step, but that the redirect message is sent to a different client than where the request came from. Such “server-side” redirection is not supported in HTTP.

It is desirable to address the above issues identified by the present applicant.

### SUMMARY

According to a first aspect of the present invention there is provided a method for use in interworking a single sign-on authentication architecture and a further authentication architecture in a split terminal scenario. The split terminal scenario is one in which authentication under the single sign-on authentication architecture is required of a browsing agent being used to access a relying party and in response, due to the interworking in the split terminal scenario, an associated authentication under the further authentication architecture is performed in relation to a separate authentication agent. A controlling agent sends a token to the authentication agent. The controlling agent sends a request to the browsing agent to return a token. The controlling agent waits for the authentication agent or a user of the authentication agent to communicate the received token to the browsing agent via a secure and/or trusted channel and for the browsing agent, in response to the earlier received request, to forward the token to the controlling agent. The controlling agent receives the token from the browsing agent. The controlling agent compares the received token with the token sent to the authentication agent to determine whether the authentication agent is authorised to perform authentication on behalf of the browsing agent and/or whether the browsing agent is authorised to act as a representative for the authentication agent. The controlling agent authenticates the browsing agent to the relying party based on the associated authentication performed in relation to the authentication agent if it is determined in the comparing step that the authentication agent and/or browsing agent is so authorised; in other words, the authenticity of the browsing agent is asserted to the relying party.

The token may comprise a session identifier.

The token sent to the authentication agent may comprise a random number or a nonce.

The token received at the controlling agent from the browsing agent may be received in an HTTP request message. The controlling agent may send an HTTP response to the browsing agent.

The controlling agent may encrypt the token sent to the authentication agent.

The controlling agent may send a piece of the controlling agent's internal state to the browsing agent, and may subsequently receive the piece of internal state back from the browsing agent. After receipt, the controlling agent may restore the piece of internal state at the controlling agent.

The piece of internal state may be sent from the controlling agent to the browsing agent with the token request. The piece of internal state may be returned from the browsing agent with the token.

The piece of internal state may relate to the authentication agent in some way, for example an identifier identifying the authentication agent.

The piece of internal state may be encrypted.

The controlling agent may receive a session or encryption key from a bootstrapping server function of the further authentication architecture to enable the session or encryption key to be used to encrypt the token or the internal state, as the case may be.

The sending of a request to the browsing agent to return a token may be done by way of sending an authentication prompt to the browsing agent.

The controlling agent may receive information identifying the authentication agent. The controlling agent may provide a web page containing an HTML form to allow the user to enter the information identifying the authentication agent.

The further authentication architecture may be a 3GPP authentication architecture.

The 3GPP authentication architecture may be a 3GPP Generic Bootstrapping Architecture.

The single sign-on authentication architecture may be an OpenID authentication architecture.

The controlling agent may comprise an OpenID Provider and Network Application Function of the 3GPP/OpenID authentication architecture.

According to a second aspect of the present invention there is provided a cryptographic method for enabling a second device of first, second and third devices to determine whether a user consents for the third device to represent the first device as the user's proxy. A cryptographic secret or token is passed from the second device to the first device. A piece of the internal state of the second device is passed from the second device to the third device. The second device waits for the token to be passed from the first device to the third device as the user's consent for the third device to represent the first device as the user's proxy, and for the piece of internal state and the token subsequently to be passed from the third device back to the second device. The second device receives the piece of internal state and the token from the third device. The second device reconstructs the internal state of the second device using the piece of internal state received from the third device. The second device compares the token received from the third device with the token previously sent to the first device to determine whether the user has consented to the third device representing the first device as the user's proxy.

The second device may discard the piece of internal state at the second device before receiving the internal state back from the third device.

The piece of internal state passed to the third device may be encrypted.

The first and third devices may be assumed to be under control of the user, either directly or indirectly.

The token may be passed from the second device to the first device over a secure and/or trusted channel between the first and second devices.

The token may be passed from the first device to the third device over a secure and/or trusted user-controlled channel between the first and third devices.

The secure and/or trusted user-controlled channel may be a narrow communication channel that is able to pass relatively short pieces of information at a relatively low rate.

The secure and/or trusted user-controlled channel may be provided by way of a manual entry of information from the first device to the third device.

The piece of internal state may relates to the first device, for example comprising information identifying the first device.

The method may comprise passing the token from the first device to the third device as the user's consent for the third device to represent the first device as the user's proxy, and passing the piece of internal state and the token from the third device to the second device.

In a split terminal scenario of a scheme for interworking a 3GPP authentication architecture and an OpenID authentication architecture, the first device may comprise an Authentication Agent of the 3GPP/OpenID authentication architecture, the second device may comprise an OpenID Provider and Network Application Function of the 3GPP/OpenID authentication architecture, and the third device may comprise a Browsing Agent of the 3GPP/OpenID authentication architecture.

The step of comparing the token received from the third device with the token previously sent to the first device may be performed using the reconstructed internal state of the second device.

The token can be considered as being representative rather than actual, such that the step of comparing the received token with the previously-sent token can be considered as amounting to comparing what is represented by the received token with what is represented by the previously-sent token.

The second aspect of the present invention can be considered to relate to a new three-party cryptographic protocol. The first aspect of the present invention can be considered as making use of the cryptographic protocol of the second aspect. However, not all steps of the second aspect cryptographic protocol need be performed in the first aspect, and there may be additional steps performed in the first aspect that do not form part of the second aspect.

According to a third aspect of the present invention there is provided an apparatus for use by a controlling agent in interworking a single sign-on authentication architecture and a further authentication architecture in a split terminal scenario where authentication under the single sign-on authentication architecture is required of a browsing agent being used to access a relying party and in response, due to the interworking in the split terminal scenario, an associated authentication under the further authentication architecture is performed in relation to a separate authentication agent. The apparatus comprises: means (or a processor or unit arranged or adapted) for sending a token to the authentication agent; means (or a processor or unit arranged or adapted) for sending a request to the browsing agent to return a token; means (or a processor or unit arranged or adapted) for receiving the requested token from the browsing agent, the authentication agent or a user of the authentication agent having communicated the received token to the browsing agent via a secure and/or trusted channel and the browsing agent, in response to the earlier received request, having forwarded the token to the controlling agent; means (or a processor or unit arranged or adapted) for comparing the received token with the token sent to the authentication agent to determine whether the authentication agent is authorised to perform authentication on behalf of the browsing agent and/or whether the browsing agent is authorised to act as a representative for the authentication agent; and means (or a processor or unit arranged or adapted) for authenticating the browsing agent to the relying party based on the associated authentication performed in relation to the authentication agent if it is determined in the comparing step that the authentication agent and/or browsing agent is so authorised.

The token received from the browsing agent may be received in an HTTP request message, and the apparatus may comprise means (or a processor or unit arranged or adapted) for sending an HTTP response to the browsing agent.

The apparatus may comprise means (or a processor or unit arranged or adapted) for encrypting the token sent to the authentication agent.

The apparatus may comprise means (or a processor or unit arranged or adapted) for sending a piece of the controlling agent's internal state to the browsing agent, means (or a processor or unit arranged or adapted) for subsequently receiving the piece of internal state back from the browsing agent, and means (or a processor or unit arranged or adapted) for restoring the piece of internal state at the controlling agent.

According to a fourth aspect of the present invention there is provided an apparatus for enabling a second device of first, second and third devices to determine whether a user consents for the third device to represent the first device as the user's proxy, with the apparatus comprising: means for passing a cryptographic secret or token from the second device to the first device; means (or a processor or unit arranged or adapted) for passing a piece of the internal state of the second device to the third device; means (or a processor or unit arranged or adapted) for receiving the piece of internal state and the token from the third device, the token having been passed from the first device to the third device as the user's consent for the third device to represent the first device as the user's proxy, and the piece of internal state and the token having subsequently been passed from the third device to the second device; means (or a processor or unit arranged or adapted) for reconstructing the internal state of the second device using the piece of internal state received from the third device; and means (or a processor or unit arranged or adapted) for comparing the token received from the third device with the token previously sent to the first device to determine whether the user has consented to the third device representing the first device as the user's proxy.

The apparatus may comprise means (or a processor or unit arranged or adapted) for discarding the piece of internal state at the second device before receiving the internal state back from the third device.

The comparing means/processor/unit may use the internal state of the second device reconstructed by the reconstructing means/processor/unit.

According to a fifth aspect of the present invention there is provided a program for controlling an apparatus to perform a method according to the first or second aspect of the present invention or which, when loaded into an apparatus, causes the apparatus to become an apparatus according to the third or fourth aspect of the present invention. The program may be carried on a carrier medium. The carrier medium may be a storage medium. The carrier medium may be a transmission medium.

According to a sixth aspect of the present invention there is provided an apparatus programmed by a program according to the fifth aspect of the present invention.

According to a seventh aspect of the present invention there is provided a storage medium containing a program according to the fifth aspect of the present invention.

The token is described above as being sent by the controlling agent (or second device) to the authenticating agent (or first device), and then (e.g. by the user) to the browsing agent (or third device), and then back to the controlling agent (or second device). It will be appreciated that such a token is intended to be representative rather than actual. A “token” in this sense is something which is used to represent something else. A token can therefore be considered merely as being representative (or a representation) of an underlying identifier or datum. The representation can be changed without losing or changing the underlying identifier or datum. In other words, the token can be changed without losing or changing what it represents. For example, in an embodiment of the present invention the token may be cryptographically morphed at one or more steps along the way. That is, when the authenticating agent (first device) receives the token, it may compute a cryptographic derivative of the token and send the derivative to the browsing agent (third device). Likewise, the browsing agent (third device) may compute (perhaps in a different way) a cryptographic derivative of whatever it received, and send that. Indeed, in one embodiment of the present invention at least the browsing agent (third device) computes a derivative of the token (as specified in the HTTP Digest Authentication protocol) and sends the derivative, not the originally-received token. The token may simply be information which can be used by another node to generate what one might normally recognise as a “cryptographic token”; that which is represented by the “information” is the same as that which is represented by the generated “cryptographic token”, and both the “information” and the generated “cryptographic token” are effectively the same token in the context of the present invention, because they both represent the same thing. Comparing a first token with a second token should therefore be understood as comparing what is represented by the first token (e.g. the underlying identifier or datum represented by the first token) against what is represented by the second token (e.g. the underlying identifier or datum represented by the second token).

An embodiment of the present invention introduces a number of advantageous enhancements over [33924].

An embodiment of the present invention presents a cryptographic protocol that, of itself, contains elements that have not previously been considered. The application of such a protocol to the 3GPP TR 33.924 split terminal scenarios of [33924], even without certain elements of the protocol, has also not been previously considered.

As mentioned previously, the 3GPP TR 33.924 draft specifies a way in which the Internet-originated OpenID and 3GPP-originated GBA authentication protocols can interoperate. Among other things, the specification brings forth a new setting, called the split terminal scenario, in which there is a trusted OP/NAF server and a trusted mobile terminal, and in which a user wishes to use (for example) a standard, unmodified Web-browser to access an OpenID-authenticated service. This poses a new security problem wherein there are two trusted parties that together attempt to authenticate a previously unknown party that has very limited computational capabilities, restricted by what is currently implemented in the Web browsers.

An embodiment of the present invention provides a new cryptographic protocol that combines two known techniques in a way not previously considered. According to an embodiment of the present invention, and in particular an embodiment of the above-described second aspect of the present invention, a network node acting as an authentication server may encrypt a piece of its internal state, related to the authentication of a previously unknown party with the help of a trusted mobile party and a user, and send said encrypted internal state and an authentication request to said previously unknown party, and later restore the state and authenticate the unknown party. The trusted mobile party participates to the protocol by conveying and/or cryptographically generating a one-time-password-like session identifier, and requesting a user in a consented action to copy or pass said session identifier to said previously unknown party. The previously unknown party participates to the protocol by receiving said encrypted internal state and authentication request from said authentication server, receiving said session identifier from said trusted mobile party, performing a fixed authentication operation, and sending said encrypted internal state and authentication reply to said authentication server.

An embodiment of the present invention is aimed at addressing the problems identified by the present applicant and as summarised above. An embodiment of the present invention provides at least one of the following advantages over [33924]: (a) better compliance with the HTTP standards; (b) more secure; (c) better supports OpenID Provider driven identifier selection; reduces state needed at the OP/NAF; (d) better aligned with users' typical ways of working; and (e) simplifies the OP/NAF implementation since it does not need to know whether the terminal is a split terminal or not.

An approach according to an embodiment of the present invention can be considered to be in better compliance with the HTTP standards than [33924], since (referring to scenario 1 by way of illustration) step 11 in FIG. 4.4.2-4 of [33924] (replicated as FIG. 3 herein and explained in Section 4.4.2 of [33924]), which is a HTTP request sent from the AA 7 to the OP/NAF 4, is effectively replaced with another HTTP request, sent instead from the BA 8 to the OP/NAF 4. The scheme as proposed in [33924] does not work according the HTTP standards, because the HTTP request comes from AA 7, but at step 12 the reply is sent to the BA 8. That is, the BA 8 receives a response but has not sent any request. Since the BA 8 has not sent any request it does not consider the response as part of any HTTP procedure it is taking part in and will hence discard the response. Such “server-side redirection” is not supported in HTTP. In an approach according to an embodiment of the present invention, the HTTP request comes from the BA 8 and the reply goes to the BA 8, which is in full compliance with the HTTP standards and well in line with the request/response model of the HTTP protocol.

Similar arguments are presented for the other two TR 33.924 scenarios below.

An approach according to an embodiment of the present invention can be considered to be more secure for two reasons. First, it verifies that data actually can flow from the AA 7 to the BA 8 (or vice versa); e.g., in Scenario 1 through the user copying the data. Second, it makes it impossible for the user just to answer along the lines of “yes, the Session IDs are similar”, in the case where they are not; [33924] cannot prevent a user from performing such an action.

An approach according to an embodiment of the present invention can be considered to better support the “Provider driven identifier selection” of [OpenID] as it optionally allows the users to enter their phone number within the authentication process instead of requiring the users' mobile identity to be bound to the OpenID User-Supplied Identifier, as [33924] does.

An approach according to an embodiment of the present invention can be considered to reduce the amount of state (memory) needed in the OP/NAF 4, since it allows the OP/NAF to “push” its state to the BA 8, an advantage that is not possible in [33924].

An approach according to an embodiment of the present invention can be considered to be better aligned with the user's motivation and typical ways of working since it requires the user to copy a short Session ID instead of trying to figure out if two strings are identical. Firstly, such an approach creates a higher motivation level for the typical user as the user feels better that the task is needed: the user actually has to pass some information on instead of comparing two identical strings. Secondly, such an approach is better aligned with already learned ways of working, since there are other applications where the user needs to copy a temporary password from a mobile terminal to a computer.

### BRIEF DESCRIPTION OF THE DRAWINGS

FIG. 1, discussed hereinbefore, illustrates an interworking architecture with a UE;

FIG. 2, also discussed hereinbefore, illustrates an interworking architecture in a split terminal scenario;

FIG. 3, also discussed hereinbefore, is a replica of FIG. 4.4.2-4 from TR 33.924 describing the signaling for scenario 1;

FIG. 4 illustrates schematically a flow of operations for Scenario 1 (GBA Push) according to an embodiment of the present invention;

FIG. 5 illustrates schematically a flow of operations for Scenarios 2 and 3 according to an embodiment of the present invention;

FIG. 6 is a schematic flowchart illustrating steps performed by a device in a method embodying the present invention;

FIG. 7 is a schematic block diagram illustrating apparatus for use to perform the method of FIG. 6; and

FIG. 8 is a schematic illustration of a node in which a method embodying the present invention can be implemented.

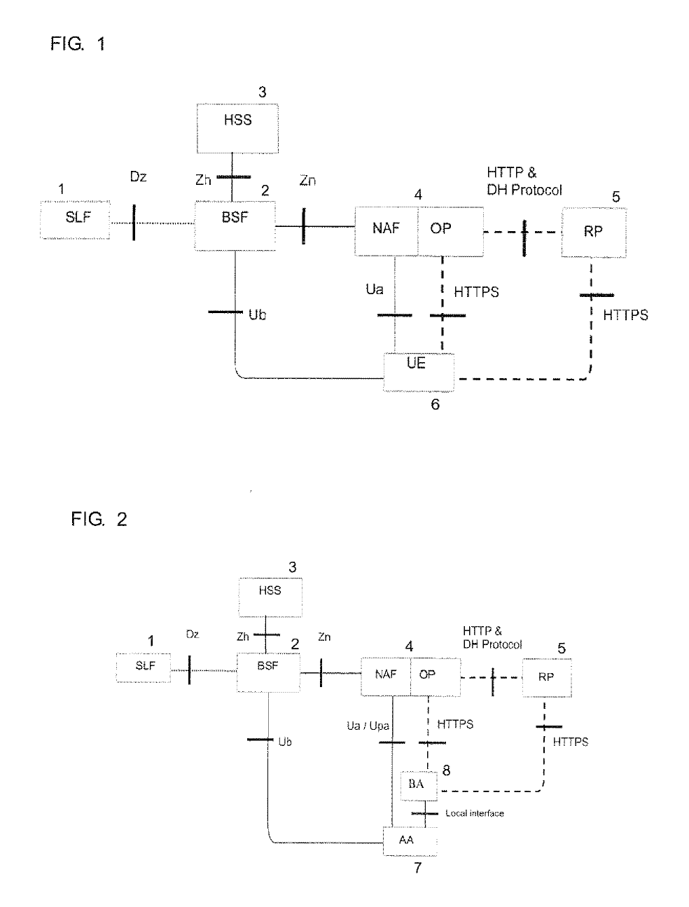

### DETAILED DESCRIPTION

As described above, the so-called split terminal GBA Internetworking Scenario of [33924] (see section 4.4.2) is divided into three scenarios (or sub-scenarios) 1 to 3. In each of them, there is an Authenticating Agent (AA), which typically is a mobile phone or other terminal device that hosts a SIM or other such credential, and a Browsing Agent (BA), which typically is a Web browser, running on a laptop, a desktop computer, or some other device that does not have a SIM.

In Scenario 3, there is assumed to be a local secure channel between the BA and AA. In the other two scenarios, a user is assumed to operate both the AA and the BA, being in full control of their input and output interfaces, i.e. the local secure channel is instantiated by the user in this case.

Even though [33924] does not directly say so, it would be apparent to the skilled person that, instead of a single user controlling both the AA and BA, there could be two users, trusting each other, one controlling one device and the other the second device, communicating over some trusted channel, e.g. over a phone call. This extension would be apparent to the person skilled in the art of cryptographic protocol analysis and it is not discussed here any further.

An overview will now be provided of the proposed enhancements with respect to [33924].

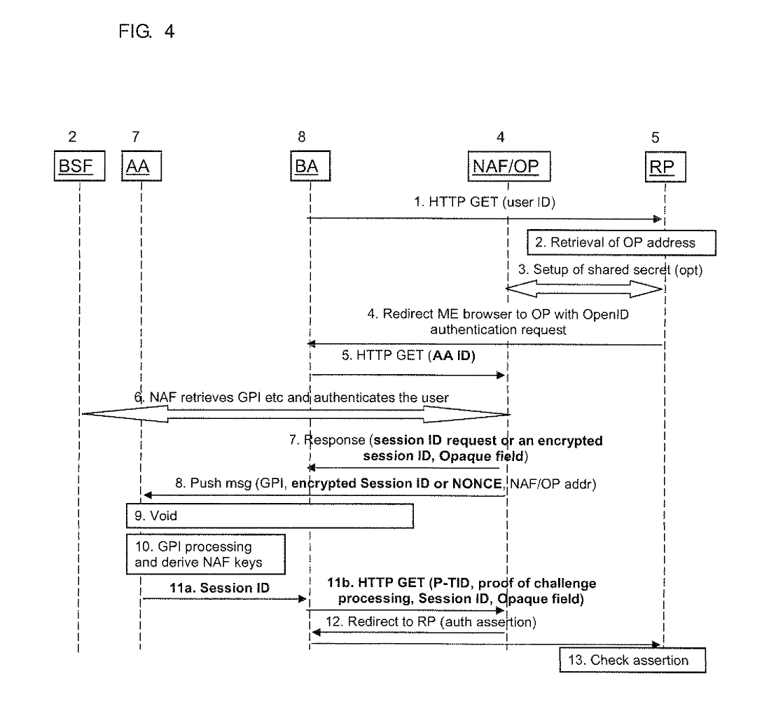

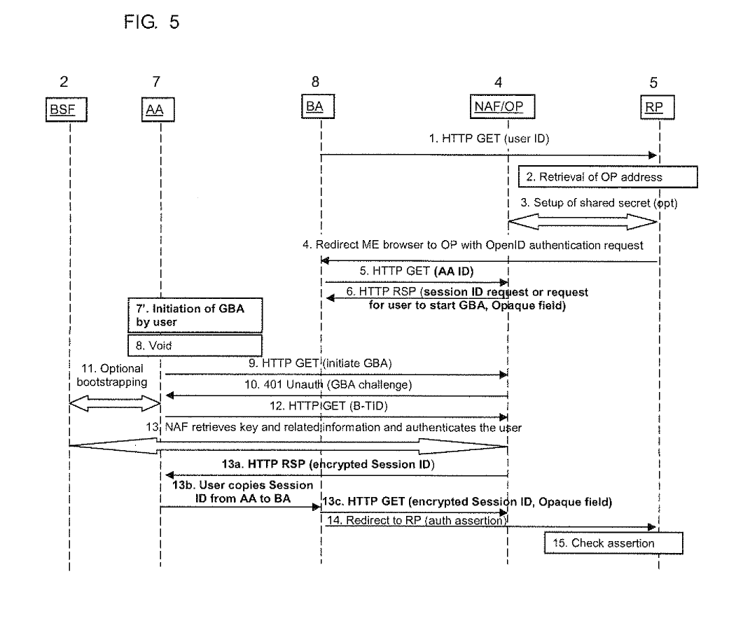

FIGS. 4 and 5 illustrate a signaling flow according to an embodiment of the present invention. FIG. 4 relates to Scenario 1, while FIG. 5 relates to Scenarios 2 and 3. The differences between [33924] and an embodiment of the present invention are highlighted in bold, and explained in detail below.

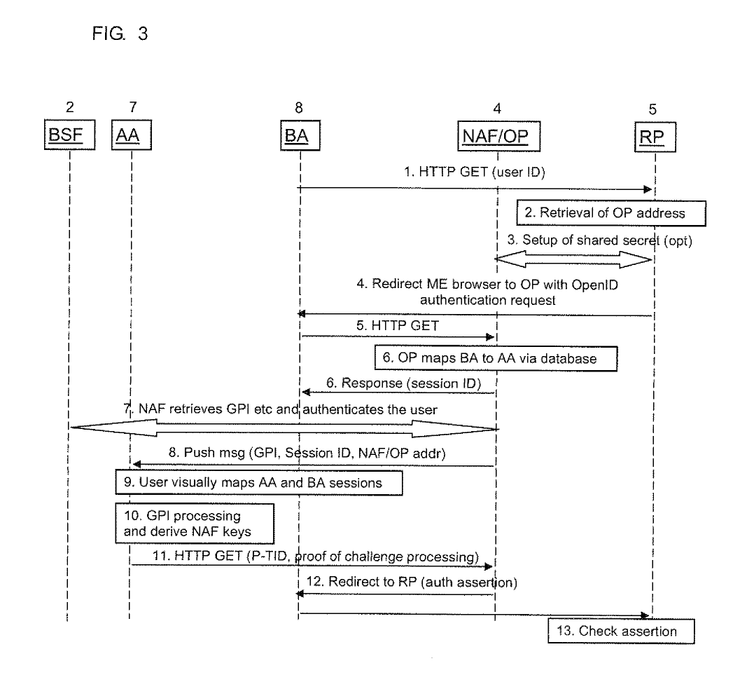

Concerning Scenario 1, the differences between [33924] and an embodiment of the present invention can be summarized as follows (an embodiment of the present invention may comprise features bringing about one or more of these differences):
In [33924], the OP/NAF 4 looks up the AA 7 identity from the BA 8 identity, using a database. According to an embodiment of the present invention, the user enters the AA 7 identifier at the BA 8, e.g. in the form of a phone number, in order to better support the OpenID “Provider driven identifier selection” feature.
In [33924], the HTTP response sent to the BA 8 (in Step 6) includes a Session Identifier to be displayed to the user. According to an embodiment of the present invention, the HTTP response sent to the BA 8 (in Step 7 of FIG. 4) includes a request for the Session Identifier and optionally an opaque data field (see below).
In [33924], the OF/NAF 4 sends first an HTTP response containing Session Identifier to the BA 8 in Step 6 of FIG. 3, retrieves the NAF keys from the Bootstrapping Server Function (BSF) 2 in Step 7 of FIG. 3, and sends the GBA Push message in Step 8 of FIG. 3. According to an embodiment of the present invention, these steps are re-ordered and enhanced so that the OP/NAF 4 first retrieves the NAF keys in the new step 6 of FIG. 4, sends an HTTP response which may contain an encrypted version of the Session Identifier to the BA 8 in Step 7 in FIG. 4, and sends an enhanced GBA push message to the AA 7 in Step 8 of FIG. 4.
In an embodiment of the present invention, the OP/NAF 4 may encrypt a piece of its internal state and send the encrypted state to the BA 8 (in Step 7 of FIG. 4) as an opaque data field. This encrypted state may then be returned to the OP/NAF 4 (in Step 11), to allow it to restore the piece of its internal state.
In [33924], the GBA push message sent to the AA 7 in Step 8 includes the same Session Identifier as was sent to the BA 8 in Step 6. According to an embodiment of the present invention, the GBA push message sent to the AA 7 in Step 8 includes either a newly generated Session Identifier, known only to the OP/NAF 4, encrypted with the GBA key Ks_(int/ext)_NAF, or, in another embodiment, a random number (nonce) that the AA 7 will use to generate a Session Identifier itself instead of the OP/NAF 4 generating the Session Identifier.
In [33924], in Step 11 in FIG. 3 the AA 7 sends an HTTP request to the OP/NAF 4. According to an embodiment of the present invention, this step is replaced by Step 11a in FIG. 4, where the user copies the Session Identifier generated by the NAF 4 (or the AA 7 from the given nonce) to the BA 8, and step 11b in FIG. 4, where the BA 8 sends an HTTP request, containing the Session Identifier and optionally the opaque data field sent by the OP/NAF 4 to the BA 8 above, to the OP/NAF 4 (P-TID is a Push TID).

Concerning Scenarios 2 and 3 of [33924], the differences between [33924] and an embodiment of the present invention can be summarized as follows (an embodiment of the present invention may comprise features bringing about one or more of these differences):
In [33924], the OP/NAF 4 looks up the AA 7 identity from the BA 8 identity, in Step 6, using a database. According to an embodiment of the present invention, the user enters the AA 7 identifier at the BA 8, e.g. in the form of a phone number, in order to better support the OpenID “Provider driven identifier selection” feature.
In [33924], the HTTP response sent to the BA 8 (in Step 6) includes a Session Identifier, to be displayed to the user. According to an embodiment of the present invention, the HTTP response sent to the BA 8 (in Step 6) includes a request for the Session Identifier and optionally an opaque data field (see below).
In [33924], the OP/NAF 4 sends first an HTTP response containing Session Identifier to the BA 8 in Step 6 and retrieves the NAF keys from the BSF 2 in Steps 9-12. According to an embodiment of the present invention, these steps are re-ordered and enhanced so that the OP/NAF 4 first retrieves the NAF keys in Steps 9-12, then sends an HTTP response that may contain an encrypted version of the Session Identifier to the AA 7, in a new Step 13a.
In an embodiment of the present invention, the OP/NAF may encrypt a piece of its internal state and send the encrypted state to the BA 8 (in Step 6) as an opaque data field. This encrypted state may then be returned to the OP/NAF 4 (in Step 13c), to allow it to restore the piece of its internal state.
In [33924], the push message sent to the AA 7 in Step 7 includes the same Session Identifier as was sent to the BA 8 in Step 6. According to an embodiment of the present invention, the HTTP response sent to the AA 7 in Step 13a includes either a newly generated Session Identifier, known only to the OP/NAF 4, encrypted with the GBA key Ks_(int/ext)_NAF, or, in another preferred embodiment, a random number (nonce) that the AA will use to generate a Session Identifier itself instead of the OP/NAF generating the Session Identifier.
In [33924], in Step 12 the AA 7 sends an HTTP request to the OP/NAF. According to an embodiment of the present invention, this step is replaced with a new Step 13b, where the user copies the Session Identifier generated by the NAF 4 or the AA 7 to the BA 8, and step 13c, where the BA 8 sends an HTTP request, containing the Session Identifier and optionally the opaque data field sent by the OP/NAF 4 to the BA 8 above, to the OP/NAF 4.

Signaling in an embodiment of the present invention will now be described in more detail.

The following text should be read with reference to FIG. 4 and/or FIG. 5. In all the three scenarios, the BA 8 initiates the OpenID+GBA protocol exchange. The BA 8 first contacts the RP (Step 1), sending an HTTP request, containing an User-Supplied identifier, as defined in [OpenID]. in Step 2, the RP 5 obtains a URL for the OP 4, as defined in [OpenID]. In the optional Step 3, the RP 5 contacts the OP 4, setting up a shared encrypted channel using for example Diffie-Heliman key exchange, as defined in [OpenID]. In Step 4, the BA 8 receives an OpenID authentication redirection from the RP 5; i.e., the BA 8 receives an HTTP 302, 303, or 307 Redirect request, as defined in Section 5.2.1 of [OpenID].

After these initial steps, within each scenario, the BA 8 sends an HTTP request to the OP/NAF 4, using the URL in the HTTP Redirect request, thereby initiating the GBA functions in the combined protocol. This step is denoted as Step 5 in all of the Scenarios 1-3. Up to this point an embodiment of the present invention need not differ from [33924].

The rest of the steps, how an embodiment of the present invention differs from [33924], and why those differences are advantageous, will now be explained in more detail. These differences are treated in turn below. The features which lead to those differences are referred to below as a first feature according to an embodiment of the present invention, a second feature according to an embodiment of the present invention, and so on. For brevity, these are subsequently referred back to as the first feature, the second feature, and so on. It will be appreciated that any single embodiment of the present invention may have one or more of these features.

A description will now be provided which relates to adding support for OpenID “Provider driven identifier selection”.

“Provider driven identifier selection” is an OpenID feature where the OpenID provider (OP) may decide, possibly through interacting with the user, which user identity it authenticates. When this feature is supported, a user may use an “anonymous” OpenID URL as an OpenID User-defined identity. The same “anonymous” OpenID URL may be used by several users, only the OP making the difference between the users.

As a first feature according to an embodiment of the present invention, instead of directly proceeding to Step 6 after Step 5, the OP/NAF 4 may perform an additional Step 5a, of sending a Web page that contains an HTML form that allows the user to enter an AA 7 identifier, e.g. his or her mobile phone number, at said HTML form. The BA 8 then returns the AA 7 identifier to the OP/NAF 4 in Step 5.

This is advantageous since it allows [33924] to be used in a context where the OpenID User-Supplied Identifier is anonymous and not bound to any specific AA 7 identity. According to this first feature, there are three extra steps in the message flow:

In a new Step 5a, the NAF/OP 4 sends an HTML form to the BA 8, asking the user to enter an AA 7 identifier, e.g. his or her phone number. This HTML form is sent in response to the HTTP GET from the BA 8. Note that other types of forms are imaginable, e.g., XML forms.

In Step 5b, the BA 8 sends a second HTTP request to the OP/NAF 4, carrying said AA 7 identifier.

In a modified Step 6, instead of using a database as suggested in [33924], the OP/NAF 4 identifies the AA 7 associated with the BA 8 based on the AA 7 identifier received at Step 5b, and uses it as described in Step 7 and thereafter in [33924], or as described later in this description.

A description will now be provided which relates to sending a session identifier request instead of the identifier itself.

In [33924], at Step 6, the OP/NAF 4 generates an authentication session identifier, which is later in the draft called Session Identifier. In [33924] it is noted that the Session identifier may be alphanumeric, or a graphic, or a picture, or even a reference to a graphic or a picture. At Step 6 of [33924], the OP/NAF 4 sends said session identifier to the BA 8.

As a second feature according to an embodiment of the present invention, instead of sending the Session Identifier to the BA 8, the OP/NAF 4 sends a request for the user to type in (echo back) the Session Identifier, as displayed at the mobile terminal (AA 7), or for Scenario 3, the Browser (BA 8) to echo back the Session Identifier as received from the AA 7 over the local secure channel.

This is advantageous for the following reasons. First, sending a request for the Session Identifier to the BA 8 instead of sending the Session Identifier itself keeps the Session Identifier more confidential, leading to protocol benefits, as explained below. Second, the mere act of asking a user to copy the Session identifier from the AA 7 to the BA 8 instead of asking the user to compare the Session Identifier as displayed at the AA 7 and BA 8 is both more secure, as the user cannot ignore making the verification, and more motivating, as the user feels stronger to be a part of the security model and actually “doing” something itself.

As a preferred embodiment of the second feature, the OP/NAF 4 may send an HTTP 401 Digest Authentication request to the BA 8, as specified in Step 6 of the TR 33.924 draft “direct GBA Interworking Scenario” (Section 4.4.1), thereby simplifying the implementation of the OP/NAF 4, as it no longer needs to send different requests at Step 6 depending on whether it is running in a split terminal scenario or not. It is noted that in a BA 8 that does not have explicit support for TR 33.924 or GBA, receiving the HTTP 401 request will cause the browser to display a dialogue box to the user.

As another embodiment of the second feature, the OP/NAF 4 may send a Web page, containing an HTML form, explicitly asking the user to enter at said HTML form the session identifier (“A password”), in the form that it will be displayed at the mobile terminal (AA 7) at Step 11a.

A description will now be provided which relates to requesting NAF parameters first and pushing them to the BA 8.

In [33924], the OP/NAF 4 first sends the Session ID in an HTTP response to the BA 8 (in Step 6) and then retrieves the GBA keys from the BSF 2 (in Step 7).

As a third feature according to an embodiment of the present invention, in Scenario 1 the OP/NAF 4 first retrieves the GBA keys from the BSF 2 (in Step 6′) and then sends an HTTP response to the BA 8 (in Step 7′). As explained above, according to the second feature according to an embodiment of the present invention, the HTTP response asks the user (or BA 8) to copy the Session Identifier from the AA 7, instead of containing the Session Identifier for comparison.

As a fourth feature according to an embodiment of the present invention, since the OP/NAF 4, as a result of the reordering of steps 6-7 in Scenario 1, possesses the GBA keys at the time of sending the HTTP response to the BA 8, the OP/NAF 4 may encrypt the GBA keys and other related data, with a key known only to the OP/NAF 4 itself, and pass the resulting opaque data blob to the BA 8.

For example, the opaque data blob may be passed to the BA 8 as an HTTP cookie, making the BA 8 to return it back on any subsequent HTTP request. As the specified maximum size for a cookie is 4 kB, and the expected size of a typical implementation of the GBA and associate state is at most a few hundred bytes, using a single cookie will typically suffice.

This allows the OP/NAF 4 to forget the GBA keys and the related state as soon as it has sent the GBA push information to the AA 7 (as explained below). This is advantageous since the possibility of temporarily forgetting the GBA keys allows the OP/NAF 4 to save memory resources, and thereby support a larger number simultaneous authentication sessions.

A description will now be provided which relates to enhancements to initiating AA 7 involvement.

In [33924], the three different scenarios outline three different ways for initiating communication with the AA 7:
In Scenario 1, at Step 8, the OP/NAF 4 sends an GBA Push request to the AA 7
In Scenario 2, at Step 7a, the OP/NAF 4 sends some other, unspecified push request to the AA 7.
In Scenario 3, at Step 7b, the BA 8 uses a local secure link, e.g. using WLAN, Bluetooth, or an USB cable, to push the Session Identifier and NAF contact address (URL) to the AA 7.

In Scenarios 1 and 2, the current TR 33.924 specifies that the push request carries the same Session Identifier as is carried in the original TR 33.924 Scenario 1 and Scenario 2-3 Step 6 to the BA 8.

At this point, the current specification states (somewhat sheepishly) that the user needs to make sure that the Session Identifier, as received by the BA 8 at Step 6, is identical to the Session Identifier received by the AA 7 at Step 7.

A description will now be provided which relates to enhancements to Scenario 1.

As a fifth feature according to an embodiment of the present invention, in the Scenario 1, the said Session Identifier is carried in the GBA push message, as specified in [33924], is additionally encrypted using a key derived via GBA push. If a random number (nonce) is used to create a Session Identifier, the random number is in this case also encrypted using keys derived via GSA Push. This is will now be specified in detail.

12. The OP/NAF 4 requests the GPI from the BSF 2 as described in TS 33.223 and Step 7 of [33924]. As a part of this process, the OP/NAF 4 receives the Ks_(ext/int)_NAF key, which acts as a shared key between the OP/NAF 4 and the AA 7.

13. The OP/NAF 4 initiates a GBA push message, to be sent to the AA 7, as specified in TS 33.223 and Step 8 of [33924].

According to the fifth feature, the Session Identifier, or a random number used to create a Session Identifier, is sent encrypted, using the Ks_(extlint)_NAF key, or a key derived from it using any well-known method, as the symmetric encryption key.

As a further advantageous feature according to an embodiment of the present invention, the AA 7 does not need to communicate back to the OP/NAF 4, as has been currently defined in Step 11 of [33924].

As a further advantageous feature according to an embodiment of the present invention, the message may not need to carry the OP/NAF 4 FQDN, as defined in Step 8 of [33924].

14. Once the AA 7 receives the GBA push message, it first processes the GPI as specified in TS 33.223 and Step 10 of Scenario 1 in [33924]. After that, according to a continuation of the fifth feature, the AA 7 uses the Ks_(ext/int)_NAF key, or a key derived from it as above, to decrypt the Session identifier, or the random number to-be-used to create a Session Identifier.

This is advantageous, since using the Ks_(ext/int)_NAF as cryptographic keying material for encrypting the Session identifier, or the related random number, makes sure that no other node but the NAF, the right AA 7 having access to the right UICC application (or whatever credential is used for authentication to the BSF), and (potentially) the BSF 2 knows the Session Identifier or the random number (if the BSF 2 can overhear the encrypted message the OP/NAF 4 sends to the AA 7).

The OP/NAF 4 knows it since it has generated the Session identifier or the random number. The AA 7 knows it since it can derive the Ks_(ext/int)_NAF key using the credential used for authentication to the BSF and the information it has received in the GPI and since it receives the encrypted Session Identifier or random number. The BSF 2 may learn the Session Identifier or the random number since it also possesses the Ks_(ext/int)_NAF key. However, that is not a problem since the BSF 2 needs to be trusted anyway.

The Session Identifier, or the random number, remaining confidential to the AA 7 and NAF is in turn advantageous as it allows us to build a more secure overall protocol, as explained below.

A description will now be provided which relates to enhancements to Scenario 2.

teaches that in Step 7a of Scenario 2 the OP/NAF 4 pushes the Session identifier in an unspecified way to the AA 7.

As a sixth feature according to an embodiment of the present invention, instead of the OP/NAF 4 pushing the information to the AA 7, means are provided for the user to initiate the GBA processing at the AA 7. This is advantageous since this allows any AA 7 that implements the plain GBA functionality, as specified in 3GPP TS 33.220 [33220] and TS 33.222 (“Generic Authentication Architecture (GAA); Access to network application functions using Hypertext Transfer Protocol over Transport Layer Security (HTTPS)”, referred to herein as [33222]), to be used in the split terminal GBA Interworking Scenario in the AA 7 role. Such an AA 7 may be, for example, a smart phone where the Web browser implements TS 33.222. This feature will now be explained in more detail.

Consider an AA 7 that implements plain GBA functionality, with the reference point Ua implemented as HTTP, as defined in TS 33.222. It is assumed, as exemplified in Clause 5.2.1 of TS 33.222, that the AA 7 implements the GBA functionality in a browser, It is further assumed, as is typical, that the browser implementation allows the user to type in URLs to initiate web page requests.

Under these assumptions, according to this feature, the message that the OP/NAF 4 sends to the BA 8 at Step 6 of Scenarios 2-3 does not contain the Session Identifier, nor does it contain a request for the Session Identifier. Instead, it contains an URL that the user is expected to type in at the AA 7, and optionally other data, such as instructions that tell the user to type in the URL at the AA 7.

Hence, instead of Step 7a, where the OP/NAF 4 initiates the GBA processing at the AA 7 by pushing a request to the AA 7, according to this feature, the user types an URL, as displayed at the BA 8, at the AA 7, thereby initiating the GBA processing. The typed URL may be a TinyURL, or any other short URL, merely redirecting the AA 7 to the actual OP/NAF 4. There is no need to identify the BA 8 or AA 7 in the URL, as the AA 7 will be authenticated as a part of the GBA processing, and the BA 8 will be authenticated later through the user tying in the Session Identifier with the BA 8, as explained below.

A description will now be provided which relates to securely delivering the Session Identifier to the AA 7 in Scenarios 2 and 3.

teaches that either in Step 7a) the OP/NAF 4 pushes the Session Identifier to the AA 7, or in Step 7b) the BA 8 pushes the Session Identifier to the AA 7. Especially in the case of Scenario 2 and Step 7a), possibly in clear text. In order to make Scenarios 2 and 3 more compatible with the fifth feature, it will now be explained how the Session Identifier, or a random number used to create the Session Identifier, can be delivered securely also in Scenarios 2 and 3.

As a seventh feature according to an embodiment of the present invention, the OP/NAF 4 (or the user, as in the case of the sixth feature) may initiate GBA processing at the AA 7 and run the GBA protocol without pushing any Session Identifier initially to the AA 7 but pushing it later in a secure form. That is, in this case, the AA 7 initiates the normal GBA procedure with the NAF, as specified in 3GPP TS 33.220 [33220] and TS 33.222 [33222], and only once the GBA protocol has been run, the Session identifier, or the random number used to generate the Session Identifier, is passed to the AA 7, protected with the GBA keys.

The enhanced steps are as follows:

7′. As explained above, in this step the user initiates GBA processing at the AA 7, either manually, for example as suggested according to the sixth feature, or through some other means, for example by transmitting an initiating message using a local channel. This step makes the OP/NAF 4 URL available to the AA 7.

8′. This step is a no operation, as there is no need for Session ID mapping.

9′. In this step, the AA 7 initiates an GBA bootstrapping run according to TS 33.220 and thereby sends an HTTP request according to TS 33.222. As an advantageous feature differentiating from [33924], this message does not need to carry the Session identifier, and thereby does not need to differ from TS 33.220 or TS 33.222 at all.

10.-13. These steps are identical to those in [33924].

13a. This is a new step, wherein the OP/NAF 4 securely sends the Session identifier, or a random number used to create a Session Identifier, to the AA 7. For example, it may encrypt the Session identifier (or the random number) using the Ks_(ext/int)_NAF key known to both the OP/NAF 4 and the AA 7. This step may be implemented, for example, as the OP/NAF 4 answering with an HTTP 200 OK message to the AA 7, with the Session Identifier being passed in an HTML document, as a parameter to a Javascript program, or by other means.

A description will now be provided which relates to cryptographically creating a Session Identifier at the AA 7.

As is discussed above, the Session Identifier may be created by the OP/NAF 4 and passed, encrypted, to the AA 7. Alternatively, the OP/NAF 4 may generate a fresh random number, and pass it, encrypted to the AA 7.

In the latter case, the AA 7 creates the actual Session Identifier. To do so, it creates an other (short) random number, and then combines the first random number received from the OP/NAF 4, the second random number generated by the AA 7 itself, and any other pre-agreed information, and uses this combination of data as a basis for generating a Session Identifier. It may then use any pre-agreed method, perhaps parameterized by the first random number, to generate the Session Identifier. For example, it may take a cryptographic hash function over the data, and use a part of the hash result as a part of the Session identifier.

From the usability point of view it is essential that the second random number and the part of the hash result are both short enough so that the user can copy them over. The exact length depends on the method of copying; for example, if the user can use a camera, these values can be longer than if the user needs to use keyboard.

For practical purposes, the second random number may be coded into 4-8 alphanumeric characters, and therefore have some 24-48 bits. The part of the hash may also be similarly encoded.

For the purposes of the rest of this document, the combination of the second random number and the part of the hash value may be considered as the Session Identifier.

A description will now be provided which relates to copying the Session Identifier to the BA 8.

In Step 9 of Scenario 1 and Step 8 of Scenarios 2 and 3 of [33924], the user is expected to verify that the Session identifier displayed by the AA 7 and the Session identifier displayed by the BA 8 are identical, and to indicate the result of this comparison to the AA 7, for example, by pressing a key or selecting an user identifier element corresponding to “match” or “no match”.

As an eighth feature according to an embodiment of the present invention, the user is requested to copy the session identifier from the AA 7 to the BA 8 if (and only if) the user wants to let the BA 8 to be authenticated with the AA 7 identity towards the OpenID Relying Party (RP 5) that originally initiated the protocol by asking the user to supply a User-Supplied Identity in Step 1 of the protocol run. This new step is identified as Step 11a in FIGS. 4 and 13b in FIG. 5.

As a preferred embodiment, the BA 8 displays a built-in, easily distinguishable dialogue to the user, asking the user to type in or otherwise input the Session Identifier from the screen or other display device of the AA 7 or attached to the AA 7. For example, if the AA 7 is a mobile phone and BA 8 is a browser running on a laptop computer, the mobile phone may display the Session Identifier on its built-in screen and the BA 8 may display a built-in HTTP Digest Authentication dialogue box for typing in the a username and password. As an example, the user may be instructed to type in a part of the Session Identifier to the username field and another part of the Session Identifier to the password field. For example, the part typed in to the username field may be the random number, suitably encoded, created by the AA 7, and the part typed in to the password field may be a part of the hash value generated by the AA 7.

As an alternate embodiment, instead of using the built-in HTTP authentication dialogue box, the BA 8 may use some other dialogue box or some other means of input, such as an HTML form, a JavaScript dialogue box, or some other means. However, a built-in, browser-integrated HTTP Digest Authentication dialogue, or other browser-integrated means of input, is preferred over a non-integrated means of input, such as a HTML form, as HTTP Digest Authentication binds the Session identifier cryptographically to the HTTP(S) session at the browser, thereby making man-in-the-middle attacks harder.

A description will now be provided which relates to the BA 8 sending Session ID and the encrypted state to the OP/NAF 4.

In [33924], at Step 12 of Scenario 1 and Step 14 of Scenarios 2-3, the OP/NAF 4 sends an HTTP Redirect to the BA 8. In practice, the HTTP protocol does not allow a server to send unsolicited redirects to a browser; furthermore, the server has supposedly already sent an HTTP 200 Ok response to the browser at Step 6. Hence, implementing Step 12/14 of [33924] requires some means outside of what is specified in [33924]; for example, the OP/NAF 4 server may send a piece of Javascript to the BA 8, implementing the so-called long poll functionality at the BA 8.

As a ninth feature according to an embodiment of the present invention, a new, user initiated step is added to the protocol, to immediately precede the HTTP Redirect step at Step 12 of Scenario 1 and Step 14 of Scenarios 2-3, designated as Step 11b in FIGS. 4 and 13c in FIG. 5. At this step, the user informs the browser that it can now send the user-copied Session Identifier back to the OP/NAF 4. Additionally, if the OP/NAF 4 has pushed a piece of its internal state to the BA 8 according to the fourth feature, the piece of state is pushed back to the OP/NAF 4 at this step.

For example, if the user was expected to copy the Session Identifier to a HTTP Digest Authentication dialogue box, as suggested according to the second and eighth features, at this step the user may click the “OK” button in the dialogue, causing the BA 8 to compute the HTTP Authentication Digest value and sending an HTTP request to the OP/NAF 4.

For example, if the piece of OP/NAF 4 internal state was pushed to the BA 8 in the form of an HTTP Cookie, the BA 8 browser will usually automatically return the state since cookies are by default returned to the site that has set them.

A description will now be provided which relates to the rest of the protocol.

When the OP/NAF 4 receives the HTTP request from the BA 8, instead of the HTTP Request from the AA 7 (as in Step 12 of Scenario 1 or Step 14 of Scenarios 1-2), it will naturally process it. As a part of this processing, it may decrypt the piece of internal state (as taught in Tuonias Aura and Pekka Nikander, “Stateless connections,” in proceedings of International Conference on Information and Communications Security ICICS'97, Beijing, November 1997, pp. 87-97, Lecture Notes in Computer Science 1334, Springer Verlag 1997, referred to later herein as [Aura Nikander], and using that state verify that the Session identifier (or nonce) stored in the internal state matches with the Session identifier (or other cryptographic token) passed in the HTTP request.

For example, in the preferred embodiment where the piece of internal state was passed as an HTTP cookie, and the Session identifier was requested as a username and a password for an HTTP Digest Authentication dialogue, this process is performed as follows:

15. The OP/NAF 4 receives an HTTP Request message from the BA 8.

16. Inspecting the message, the OP/NAF 4 finds an HTTP cookie, named appropriately so that the OP/NAF 4 can expect the cookie to contain an encrypted copy of a previous piece of its internal state, related to the BA 8 and to some AA 7.

17. Using a key known only to the OP/NAF 4 itself, the OP/NAF 4 can decrypt the contents of the cookie, revealing the piece of its internal state. The OP/NAF 4 may verify the integrity of the state implicitly from any redundancy in the state encoding, explicitly through inclusion of a Message Authentication Code (MAC), or in a combination thereof. The state may include a timestamp, making the OP/NAF 4 to discard any too old state and terminate the protocol.

18. The OP/NAF 4 may now restore the piece of its state, containing the identity of the AA 7, the previously created GBA key Ks_(ext/int)_NAF, a random number used as the Session identifier, as a nonce that was used by the AA 7 to create the Session Identifier, and other information.

19. The OP/NAF 4 may now take the username field from the HTTP Digest Authentication reply and convert it to the random number that the AA 7 used to generate the Session Identifier.

20. Using the random number from the recovered internal state, the username, and any other pre-agreed information as discussed above, the OP/NAF 4 may now compute the same hash value as the AA 7 did when forming the Session Identifier, and take the same part of the hash value as the AA 7 picked, to be displayed to the user for copying.

21. Given the piece of the hash value, the OP/NAF 4 may now use the standard HTTP Digest Authentication methods to verify that the value that the user typed in to the HTTP Digest Authentication Dialogue was indeed the same value as the OP/NAF 4 got in result of performing the above computations.

If the HTTP Digest Authentication verification succeeds, the OP/NAF 4 may conclude that the Session Identifier, generated by some party using the nonce previously generated by the OP/NAF 4 itself, was passed through some means of communication from that party to the BA 8, and the BA 8 used said the pieces of the Session Identifier as input values to the HTTP Digest Authentication process. As the OP/NAF 4 may safely assume, as discussed above, that the nonce left the OP/NAF 4 only in a form protected by the Ks_(ext/int)_NAF key associated with the AA 7, it may conclude that the party that formed the Session Identifier must be a party that also knows the Ks_(ext/int)_NAF key, i.e. the AA 7, the BSF 2, or any other party that the AA 7 or the BSF 2 has revealed the key, the nonce, or both. Hence, as the AA 7 and the BSF 2 are assumed to secure and not to reveal the Ks_(ext/int)_NAF or the nonce to any other party, the OP/NAF 4 may assume that it must have been the AA 7 that has created the Session Identifier and made the Session Identifier available for passing it to the HTTP Digest Authentication process at the BA 8.

A description will now be provided which relates to other embodiments.

A variation where the Session identifier is not generated by the NAF but by the AA 7:

Sid=nonce,HASH(coarse-time clock, nonce, Ks_(ext/int)_NAF) where nonce is quite short to be typeable, and only a few bits out of the hash result are used.

A variation where the Session identifier is a picture or a graphic, displayed at the screen of the AA 7, and copied by the user by taking a picture of the picture or graphic using a camera integrated to or attached to the BA 8. For example, the picture may be a 2D bar code for easier digital processing.

As mentioned previously, an embodiment of the second aspect of the present invention can be considered to relate to a new three-party cryptographic protocol. An embodiment of the first aspect of the present invention can be considered as making use of this cryptographic protocol (though not all steps of the second aspect cryptographic protocol need be performed in the first aspect, and there may be additional steps performed in the first aspect that do not form part of the second aspect).

The cryptographic protocol can be described as follows. In its general sense (second aspect), the cryptographic protocol is performed between first, second and third devices. To illustrate how the cryptographic protocol can apply to the interworking of OpenID and 3GPP authentication architectures (first aspect), the correspondence between the first, second and third devices and the nodes described above (e.g. see FIGS. 3 and 4) is provided below.
The first and the second device (AA 7 and OP/NAF 4) have a pre-existing (indirect) trust (business) relationship and a means of producing a new, fresh trusted shared secret (Ks_(ext/int)_NAF, which is a NAF specific key derived from Ks in GBA),

In a preferred embodiment, the existing trust relationship is indirect, established through a trusted fourth device (BSF 2), and the trusted shared secret is created by the first device (AA 7) and trusted fourth device (BSF 2) which then passes the shared secret to the second device (OP/NAF 4). However, the trust relationship could be direct, and the means for producing the new trusted shared secret could also be direct, based on both of the parties possessing a permanent shared secret, mutually trusted public keys, or other cryptographic keys that would allow the parties to directly trust each other.
The first and the third device (AA 7 and BA 8) are assumed to be under the control of a single user (either directly or indirectly), and the user is assumed to be in the position to decide whether he or she trusts the second device (BA 8) as much as the first device (AA 7) under the specific usage scenario.
There is a narrow communication channel between the first (AA 7) and third device (BA 8), wherein “narrow” means that the channel can pass only relatively short binary strings and at a relatively low rate.

For example, a user may copy a string from the screen of the first device (AA 7) to the third device (BA 8), using the keyboard of the third device, or a user may use a camera that is part of the third device or attached to the third device to copy a picture shown on the screen of the first device (AA 7).
The goal of the protocol is to allow the second device (OP/NAF 4) to verify whether the user trusts the third device for the given usage context, i.e., if the user is willing to let the first device (AA 7) to vow for the second device to represent the user, at least temporarily within the current usage context, as if the user were using the first device (AA 7) instead.

For example, assuming the first device (AA 7) were authorized by a bank to be used by the user to perform electronic transactions, the goal of the protocol was to verify if the user wants to (temporarily) delegate this authorization to the third device (BA 8), so that the user can (for this specific transaction) perform the transaction using the third device (BA 8) instead of the first device (AA 7).

The core of the protocol can be summarized as follows:

1. A third party (BA 8) initiates the process by sending to a second party (OP/NAF 4) a message (indicating that there is an external party (OpenID RP 5) that wants to verify whether a user is consenting that the third party (BA 8) may represent the first party (AA 7) as the user's proxy.) Without loss of generality, the third party (BA 8) may send said message also for some other purpose.

2. The second party (OP/NAF 4) creates or obtains a fresh shared secret that it will soon securely share with the first party (AA 7).

3. The second party (OP/NAF 4) creates or obtains a fresh random number that no other party knows.

4. The second party (OP/NAF 4) encrypts said random number with said shared secret. In another embodiment it is not necessary to encrypt the random number before sending it to the AA 7. The token derivation could be made from the random value and the shared secret. In another embodiment it is not necessary to encrypt the random number before sending it to the AA 7. The token derivation could be made from the random value and the shared secret.

5. The second party (OP/NAF 4) sends the shared secret, or sufficient information for creating the shared secret, via a secure means, and said encrypted or clear text random number, to the first party.

Without losing the essential properties of the protocol, the first and second parties may also perform some other protocol that results in their knowing of a fresh shared secret and the second party sending the first party a fresh random number (nonce) by a means (e.g. encryption) so that only the first party (or any trusted other party) can learn the random number.

6. The second party (OP/NAF 4) encrypts its internal state concerning the first party (AA 7) using a key that only the second party knows. This state contains at least the following pieces of information:
an identifier identifying the first party (AA 7),
the fresh shared secret (Ks_(ext/int)_NAF) that was created in Step 2,
the fresh random number (nonce) that was created in Step 3,
   and may additionally contain any or none of the following pieces of information:
current time at the time encrypting the internal state,
usage information specifying an application specific meaning of why the second party is doing the verification,
any other pieces of information agreed in a specification and known to the second party (OP/NAF 4), and/or
a Message Authentication Code (MAC), optionally keyed (HMAC), covering some or all of the other pieces of information.

7. The second party (OP/NAF 4) sends its encrypted internal state to the third party (BA 8), and discards the state.

Hence, after discarding the state the second party does not store any state related to the particular protocol run; the only state it needs to have is the key it used in Step 6 to encrypt the internal state. That key may be used with a large number of concurrent protocol runs. This is advantageous since it allows the second party (OP/NAF 4) to serve more concurrent protocol runs than what it could do if it would need to remember the state.

8. The third party (BA 8) retains the encrypted state sent by the second party (OP/NAF 4), and prepares to receive a token from the first party (AA 7).

For example, the third party (BA 8) may display a dialogue box requesting the user to copy the token using a keyboard, as the first party (AA 7) will show it.

9. The first party (AA 7) decrypts said fresh random number (if it was encrypted), and forms a token from the random number itself, from a part of the random number, or from a derivative of the random number, and from any other pre-agreed pieces of information, using a pre-agreed method.

That is, the method used to create the token is defined in the protocol specification. It can also be dynamic, as is easily understood to the man skilled in the art, in the sense that the second party (OP/NAF 4) may send encoded instructions to the first party (AA 7) on which method the second party expects the first party to create to token.

10. The first party (AA 7) displays the formed token on its display, or otherwise makes it available to the user so that the user can, via a consented action, make the token available to the third party (BA 8).

For example, if the first party displays the token as an alphanumeric character string, the user can copy the character string using a keyboard that may be an integral part of or that may be attached to the third party. As another example, if the first and third party are able to communicate over a local radio link, such as one formed with the BlueTooth technology, the user can instruct the first party to make the token available to the third party.

11. The user decides if it wants the third party (BA 8) to act as his or her representative, in the current usage context, instead of the first party (AA 7). if the user decides that it does not trust the BA 8, the protocol terminates at this step.

For example, in a typical usage situation, where the first party is a mobile phone, where the third party is a web browser running on, for example a laptop or desktop computer, where the user has initiated the process by navigating to a secure web site using the web browser, and where the browser has shown suitable instructions to the user at step 8, a positive decision is usually very simple and natural to the user.

12. As a consented action, the user copies the token(s) from the first party (AA 7) to the third party (BA 8).

13. The third party (BA 8) sends the token, or a cryptographic derivative of the token using a pre-agreed method, and the encrypted internal state of the second party back to the second party (OP/NAF 4).

14. The second party (OP/NAF 4) reconstructs its internal state from the received message.

15. The second party (OP/NAF 4) performs the following:
verifies that the received encrypted internal state is fresh enough
picks up the random number created in Step 3 above from the restored internal state, and computes a token using the method of Step 9,
takes the token, or creates a cryptographic derivative of the token using the method of Step 13, and
verifies that the received token, or the cryptographic derivative of the received token, and the computed token, or the cryptographic derivative of the computed token, are equal.

If the second party (OP/NAF 4) is able to verify all of the above, it may decide to let the third party (BA 8) to represent the user (as a proxy for the first party) within the usage context in which the particular protocol run was performed.

Steps 1 to 5 above are typical to many cryptographic protocols. However, the combination and order of actions in Steps 6 to 8, in particular, has not been previously considered. While encrypting a piece of internal state and sending it to another protocol party (Steps 6 to 7) is taught e.g. in [Aura Nikander], the combination of sending the state to another party (Steps 6 to 7) and then making that party wait for further cryptographic input from the user (Step 8) has not been previously considered.

Step 9 is a typical step performed in cryptographic protocols.

While passing a token securely to a mobile terminal and letting a user copy a token to a web browser has been previously considered, the combination of such copying (Steps 10 to 12), the web browser sending the token and a piece of encrypted internal state (Step 13), and the verifier (OP/NAF 4) reconstructing the internal state (Step 14) has not been previously considered. That is, while Steps 10 to 12 may have been previously considered, and while Steps 13 to 14 may have been previously considered, their specific combination has not been previously considered.

Step 15 is a typical step performed in cryptographic protocols.

One differentiating feature of the protocol is the very combination of a) sending the internal state to another party and getting it back (Steps 6 to 7, 13 to 14) and b) passing a cryptographic secret (a token) over a user-controlled channel (Steps 5, 8, 9, 10 to 12, 13). The differentiation is increased when the internal state does not itself contain the token but sufficient means to verify that the token was indeed created within the protocol run, since such an arrangement binds the two otherwise well known methods more specifically with each other.

Other differentiating features of an embodiment of the present invention relate to the specific application to enhancing the 3GPP TR 33.924 draft, as set out previously.

As another example, in an attack situation where an attacker has the control over a web browser working in the third party role but does not have access to the mobile phone showing the token, the attacker is typically not able to successfully perform the protocol. The legitimate user of the mobile phone gets a token, but he or she does not know what to do with it. Consider a situation where an attacker controls the real BA 8 and display the user a fake BA 8, BA 8′.

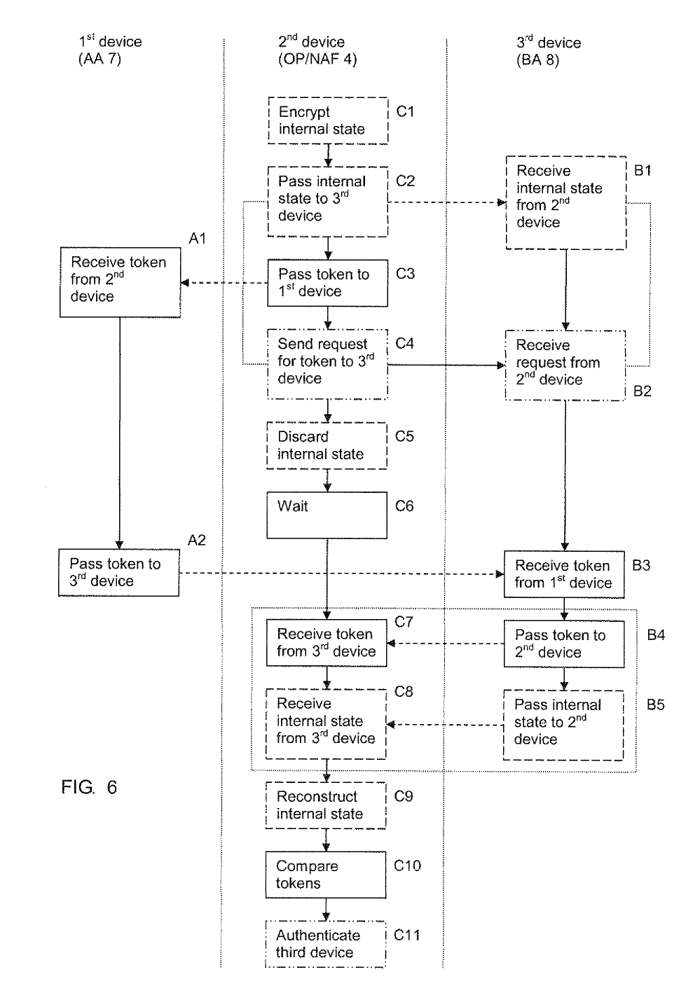

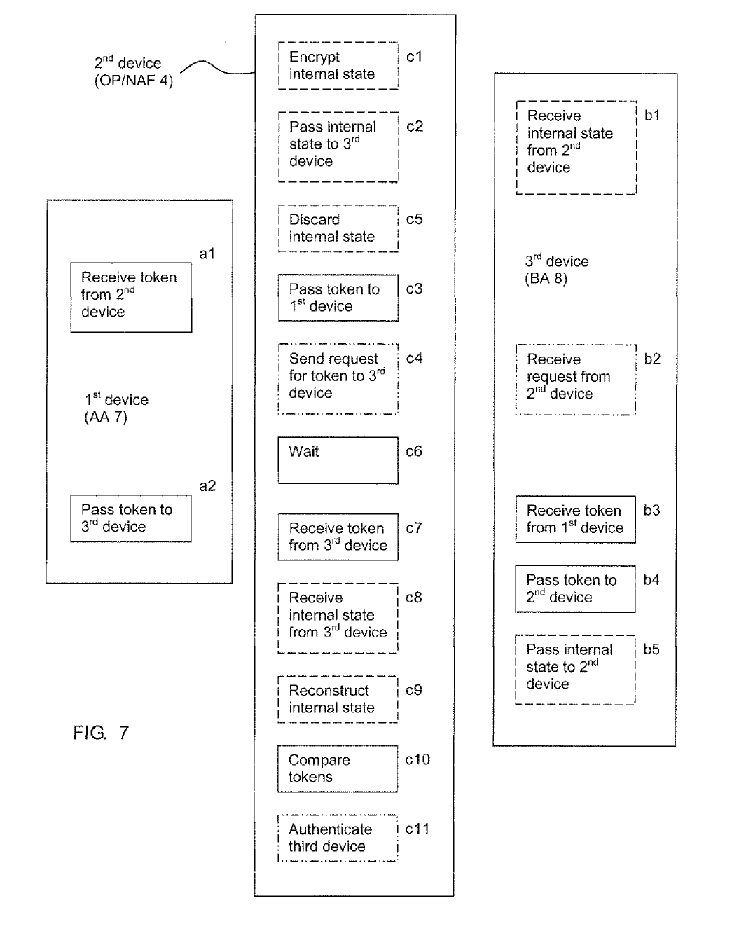

Both the first and second aspects of the present invention can be summarised with reference to FIGS. 6 and 7. FIG. 6 is a schematic flowchart illustrating steps performed by first, second and third devices; in the context of the first aspect those devices correspond respectively to the AA 7, OP/NAF 4 and BA 8. Those steps that are specific to an embodiment of the second aspect and optional in an embodiment of the first aspect are indicated in FIG. 6 by a dashed outline, while those steps that are specific to an embodiment of the first aspect and optional in an embodiment of the second aspect are indicated in FIG. 6 by a dot-dash outline. In case the outline type is not clearly visible in FIG. 6, those steps in dashed outline are C1, C2, C5, C8, C9, B1 and B5, and those steps in dot-dash outline are C4, C11 and 82.

The method of FIG. 6 will first be described within the context of an embodiment of the second aspect of the present invention, which relates to a cryptographic method for enabling a second device of first, second and third devices to determine whether a user consents for the third device to represent the first device as the user's proxy. In step C1 a piece of the internal state of the second device is encrypted. In step C2, the piece of internal state is passed from the second device to the third device, and received at the third device in step B1. In step C3, a cryptographic secret or token is passed from the second device to the first device, and received at the first device in step A1. Steps C4 and B2 may be performed, a description for which is provided below (if performed, the token request and the internal state may be passed by way of a single message or separate messages; in the former, steps C2/B1 and C4/B2 would effectively be merged). In step C5, the internal state is discarded at the second device. The second device then waits in step C6 for the token to be passed from the first device to the third device as the user's consent for the third device to represent the first device as the user's proxy, and for the piece of internal state and the token subsequently to be passed from the third device to the second device. The first device (or a user of the first device) passes the token to the third device in step A2, and the third device receives the token in step B3. The third device passes the token to the second device in step B4, and the second device receives the token in step C7. The third device passes the piece of internal state to the second device in step B5, and the second device receives the piece of internal state in step C8. The token and the piece of internal state may be passed by way of a single message or separate messages. In step C9 the second device reconstructs the internal state of the second device using the piece of internal state received from the third device. In step C10, the second device compares the token received from the third device in step C7 with the token previously sent to the first device in step C3 to determine whether the user has consented to the third device representing the first device as the user's proxy. Step C11 may be performed, a description for which is provided below

The method of FIG. 6 will now be described within the context of an embodiment of the first aspect of the present invention, which relates to the interworking of a single sign-on (e.g. OpenID) authentication architecture and a further (e.g. 3GPP) authentication architecture in a split terminal scenario where authentication under the single sign-on authentication architecture is required of a browsing agent (third device) being used to access a relying party (not shown) and in response, due to the interworking in the split terminal scenario, an associated authentication under the further authentication architecture is performed in relation to a separate authentication agent (first device). In FIG. 6 and in the following description relating to FIG. 6, the first device represents the authentication agent (e.g. AA 7), the second device represents a controlling agent (e.g. OP/NAF 4), and the third device represents the browsing agent (e.g. BA 8). Steps C1, C2 and B1 may be performed, a description for which is provided above. In step C3, a cryptographic secret or token is passed from the second device to the first device, and received at the first device in step A1. In step C4, the second device sends a request to the third device to return a token for comparing with the token sent to the first device in step C3. The request is received in step B2 by the third device. Step C5 may be performed, a description for which is provided above. The second device then waits in step C6 for the token to be passed from the first device to the third device as the user's consent for the third device to represent the first device as the user's proxy. The first device (or a user of the first device) passes the token to the third device in step A2, and the third device receives the token in step B3. The third device passes the token to the second device in step B4, and the second device receives the token in step C7. Steps C8, C9 and B5 may be performed (in which case step C6 also involves waiting for the passing of the piece of internal state), a description for which is provided above. In step C10, the second device compares the token received from the third device in step C7 with the token previously sent to the first device in step C3 to determine whether the first device is authorised to perform authentication on behalf of the third device and/or whether the third device is authorised to act as a representative for the first device. In step C11 the third device is authenticated based on the associated authentication performed in relation to the first device if it is determined in the comparing step C10 that the first device and/or third device is so authorised.

FIG. 7 is a schematic block diagram illustrating apparatus for use to perform the method of FIG. 6. For each of the functional blocks of FIG. 6, there is a corresponding means or processing unit illustrated in FIG. 7 for performing the function represented by that functional block; like reference numerals have been applied, so that for example processing unit c1 is provided for performing the function of step C1. Each block of FIG. 7 can be considered as representing a processing unit or means for performing the function stated in the block concerned. Unit c6 can be considered as being linked logically with units c7 and/or c8, since in practice the apparatus may not have actual means for waiting, but there would simply be a time period (“waiting”) which ends with the receipt of the token and/or the internal state; the same applies to step C6 itself.

It will be appreciated that it is not important to an embodiment of the present invention how the credential (e.g., SIM or USIM) used to authenticate to GBA is realized. For example, it is possible to implement a USIM or SIM application in software. In addition, 3GPP is currently looking at the possibility to specify a password-based authentication to GBA, where the password will serve the same purpose as the SIM/USIM in the current specifications. For use cases where password based authentication is used there is no need for a SIM or USIM application. Therefore, the credential used in an authentication procedure with GSA could be a SIM, a USIM, a password, a pre-shared key, a certificate with corresponding private and public keys, or some other credential (or combination of credentials). The credential (or combination of credentials) could be realized in software, hardware, firmware or any other type of medium.

It will be appreciated that operation of one or more of the above-described components can be provided in the form of one or more processors or processing units, which processing unit or units could be controlled or provided at least in part by a program operating on the device or apparatus. The function of several depicted components may in fact be performed by a single component. A single processor or processing unit may be arranged to perform the function of multiple components. Such an operating program can be stored on a computer-readable medium, or could, for example, be embodied in a signal such as a downloadable data signal provided from an Internet website. Any appended claims now or in future are to be interpreted as covering an operating program by itself, or as a record on a carrier, or as a signal, or in any other form.

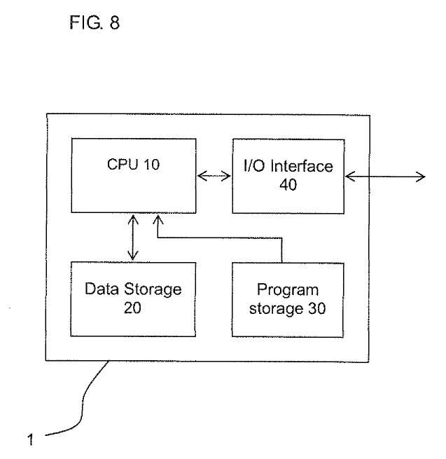

FIG. 8 is a schematic illustration of a node 1 in which a method embodying the present invention can be implemented. A computer program for controlling the node 1 to carry out a method embodying the present invention is stored in a program storage 30. Data used during the performance of a method embodying the present invention is stored in a data storage 20. During performance of a method embodying the present invention, program steps are fetched from the program storage 30 and executed by a Central Processing Unit (CPU) 10, retrieving data as required from the data storage 20. Output information resulting from performance of a method embodying the present invention can be stored back in the data storage 20, or sent to an Input/Output (I/O) interface 40, which may comprise a transmitter for transmitting data to other nodes, as required. Likewise, the Input/Output (I/O) interface 40 may comprise a receiver for receiving data from other nodes, for example for use by the CPU 10.

The appended signaling diagrams can be considered not only to depict a series of messages exchanged and method steps performed by the various nodes, but also to depict apparatus for preparing and exchanging those messages or performing those method steps. in addition, for the sake of completeness, any message which is shown or described as being sent from node A to node B implicitly includes the step of node A sending the message as well as the step of node B receiving the message, and means at nodes A and B for performing those steps.

It will be appreciated by the person of skill in the art that various modifications may be made to the above described embodiments without departing from the scope of the present invention as defined by the appended claims. For example, it will be readily appreciated that although the above embodiments are described with reference to parts of a 3GPP network, an embodiment of the present invention will also be applicable to like networks, such as a successor of the 3GPP network, having like functional components. Likewise, an embodiment of the present invention is not restricted to interworking of 3GPP and OpenID authentication architectures specifically. The invention could be applied to the interworking of any single sign-on authentication (OpenID being one example) architecture with any other type of authentication architecture (3GPP being one example). Therefore, the terms 3GPP and OpenID and associated or related terms used in the above description and in the appended drawings and any appended claims now or in the future are to be interpreted accordingly.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms may be employed herein, they are used in a generic and descriptive sense only and not for purposes of limitation.

1. A method for use in interworking a single sign-on authentication architecture and a further authentication architecture in a split terminal scenario where authentication under the single sign-on authentication architecture is required of a browsing agent being used to access a relying party and in response, due to the interworking in the split terminal scenario, an associated authentication under the further authentication architecture is performed in relation to a separate authentication agent, the method comprising, at a controlling agent:
sending a token to the authentication agent;
sending a request to the browsing agent to return a token;
receiving the token from the browsing agent, the authentication agent or a user of the authentication agent having communicated the received token to the browsing agent via a secure and/or trusted channel and the browsing agent, in response to the earlier received request, having forwarded the token to the controlling agent;
comparing the received token with the token sent to the authentication agent to determine whether the authentication agent is authorised to perform authentication on behalf of the browsing agent and/or whether the browsing agent is authorised to act as a representative for the authentication agent; and
authenticating the browsing agent to the relying party based on the associated authentication performed in relation to the authentication agent if it is determined in the comparing step that the authentication agent and/or browsing agent is so authorised.

2. A method as claimed in claim 1, wherein the token received from the browsing agent is received in an HTTP request message, and comprising sending an HTTP response to the browsing agent.

3. A method as claimed in claim 1, comprising encrypting the token sent to the authentication agent.

4. A method as claimed in claim 3, comprising receiving a session or encryption key from a bootstrapping server function of the further authentication architecture before the encrypting step to enable the session or encryption key to be used in the encryption.

5. A method as claimed in claim 1, comprising sending a piece of the controlling agent's internal state to the browsing agent, subsequently receiving the piece of internal state back from the browsing agent, and restoring the piece of internal state at the controlling agent.

6. A method as claimed in claim 5, wherein the piece of internal state is sent to the browsing agent with the token request, and the piece of internal state is returned from the browsing agent with the token.

7. A method as claimed in claim 5, comprising encrypting the piece of internal state.

8. A method as claimed in claim 7, comprising receiving a session or encryption key from a bootstrapping server function of the further authentication architecture before the encrypting step to enable the session or encryption key to be used in the encryption.

9. A method as claimed in claim 1, wherein the token comprises a session identifier.

10. A method as claimed in claim 1, wherein the token sent to the authentication agent comprises a random number or a nonce.

11. A method as claimed in claim 1, wherein the sending of a request to the browsing agent to return a token is done by way of sending an authentication prompt to the browsing agent.

12. A method as claimed in claim 1, wherein the further authentication architecture is a 3GPP authentication architecture.

13. A method as claimed in claim 12, wherein the 3GPP authentication architecture is a 3GPP Generic Bootstrapping Architecture.

14. A method as claimed in claim 1, wherein the single sign-on authentication architecture is an OpenID authentication architecture.

15. A method as claimed in claim 14, wherein the further authentication architecture is a 3GPP authentication architecture, and wherein the controlling agent comprises an OpenID Provider and Network Application Function of the 3GPP/OpenID authentication architecture.

16. A method as claimed in claim 1, wherein the token is representative rather than actual, and wherein the step of comparing the received token with the previously-sent token amounts to comparing what is represented by the received token with what is represented by the previously-sent token.

17. An apparatus for use by a controlling agent in interworking a single sign-on authentication architecture and a further authentication architecture in a split terminal scenario where authentication under the single sign-on authentication architecture is required of a browsing agent being used to access a relying party and in response, due to the interworking in the split terminal scenario, an associated authentication under the further authentication architecture is performed in relation to a separate authentication agent, the apparatus comprising:
means for sending a token to the authentication agent;
means for sending a request to the browsing agent to return a token;
means for receiving the requested token from the browsing agent, the authentication agent or a user of the authentication agent having communicated the received token to the browsing agent via a secure and/or trusted channel and the browsing agent, in response to the earlier received request, having forwarded the token to the controlling agent;
means for comparing the received token with the token sent to the authentication agent to determine whether the authentication agent is authorised to perform authentication on behalf of the browsing agent and/or whether the browsing agent is authorised to act as a representative for the authentication agent; and
means for authenticating the browsing agent to the relying party based on the associated authentication performed in relation to the authentication agent if it is determined by the comparing means that the authentication agent and/or browsing agent is so authorised.

18. An apparatus as claimed in claim 17, wherein the token received from the browsing agent is received in an HTTP request message, and comprising means for sending an HTTP response to the browsing agent.

19. An apparatus as claimed in claim 17, comprising means for encrypting the token sent to the authentication agent.

20. An apparatus as claimed in claim 17, comprising means for sending a piece of the controlling agent's internal state to the browsing agent, means for subsequently receiving the piece of internal state back from the browsing agent, and means for restoring the piece of internal state at the controlling agent.

21. An apparatus as claimed in claim 17, wherein the token comprises a session identifier.

22. An apparatus as claimed in claim 17, wherein the token sent to the authentication agent comprises a random number or a nonce.

23. An apparatus as claimed in claim 17, wherein the sending of a request to the browsing agent to return a token is done by way of sending an authentication prompt to the browsing agent.

24. An apparatus as claimed in claim 17, wherein the further authentication architecture is a 3GPP authentication architecture.

25. An apparatus as claimed in claim 24, wherein the 3GPP authentication architecture is a 3GPP Generic Bootstrapping Architecture.

26. An apparatus as claimed in claim 17, wherein the single sign-on authentication architecture is an OpenID authentication architecture.

27. An apparatus as claimed in claim 26, wherein the further authentication architecture is a 3GPP authentication architecture, and wherein the controlling agent comprises an OpenID Provider and Network Application Function of the 3GPP/OpenID authentication architecture.

28. An apparatus as claimed in claim 17, wherein the token is representative rather than actual, and wherein the step of comparing the received token with the previously-sent token amounts to comparing what is represented by the received token with what is represented by the previously-sent token.

29. A cryptographic method for enabling a second device of first, second and third devices to determine whether a user consents for the third device to represent the first device as the user's proxy, and the method comprising: passing a cryptographic secret or token from the second device to the first device; passing a piece of the internal state of the second device to the third device; receiving the piece of internal state and the token from the third device, the token having been passed from the first device to the third device as the user's consent for the third device to represent the first device as the user's proxy, and the piece of internal state and the token having subsequently been passed from the third device to the second device; reconstructing the internal state of the second device using the piece of internal state received from the third device; and comparing the token received from the third device with the token previously sent to the first device to determine whether the user has consented to the third device representing the first device as the user's proxy.

30. A method as claimed in claim 29, comprising discarding the piece of internal state at the second device before receiving the internal state back from the third device.

31. A method as claimed in claim 29, wherein the token is passed from the second device to the first device over a secure and/or trusted channel between the first and second devices.

32. A method as claimed in claim 29, wherein the token is passed from the first device to the third device over a secure and/or trusted user-controlled channel between the first and third devices.

33. A method as claimed in claim 32, wherein the secure and/or trusted user-controlled channel is a narrow communication channel that is able to pass relatively short pieces of information at a relatively low rate.

34. A method as claimed in claim 32, wherein the secure and/or trusted user-controlled channel is provided by way of a manual entry of information from the first device to the third device.

35. A method as claimed in claim 29, comprising passing the token from the first device to the third device as the user's consent for the third device to represent the first device as the user's proxy, and passing the piece of internal state and the token from the third device to the second device.

36. A method as claimed in claim 29, wherein the step of comparing the token received from the third device with the token previously sent to the first device is performed using the internal state of the second device reconstructed in the reconstructing step.

37. A method as claimed in claim 29, wherein the piece of the internal state passed to the third device is encrypted.

38. A method as claimed in claim 29, wherein the piece of the internal state relates to the first device, for example comprising information identifying the first device.

39. A method as claimed in claim 29, wherein, in a split terminal scenario of a scheme for interworking a 3GPP authentication architecture and an OpenID authentication architecture, the first device comprises an Authentication Agent of the 3GPP/OpenID authentication architecture, the second device comprises an OpenID Provider and Network Application Function of the 3GPP/OpenID authentication architecture, and the third device comprises a Browsing Agent of the 3GPP/OpenID authentication architecture.

40. A method as claimed in claim 29, wherein the token is representative rather than actual, and wherein the step of comparing the received token with the previously-sent token amounts to comparing what is represented by the received token with what is represented by the previously-sent token.

41. An apparatus for enabling a second device of first, second and third devices to determine whether a user consents for the third device to represent the first device as the user's proxy, and the apparatus comprising:
means for passing a cryptographic secret or token from the second device to the first device;
means for passing a piece of the internal state of the second device to the third device;
means for receiving the piece of internal state and the token from the third device, the token having been passed from the first device to the third device as the user's consent for the third device to represent the first device as the user's proxy, and the piece of internal state and the token having subsequently been passed from the third device to the second device;
means for reconstructing the internal state of the second device using the piece of internal state received from the third device; and
means for comparing the token received from the third device with the token previously sent to the first device to determine whether the user has consented to the third device representing the first device as the user's proxy.

42. An apparatus as claimed in claim 41, comprising means for discarding the piece of internal state at the second device before receiving the internal state back from the third device.

43. An apparatus as claimed in claim 41, wherein the comparing means use the internal state of the second device reconstructed by the reconstructing means.

44. An apparatus as claimed in claim 41, wherein the piece of the internal state passed to the third device is encrypted.

45. An apparatus as claimed in claim 41, wherein the piece of the internal state relates to the first device, for example comprising information identifying the first device.

46. An apparatus as claimed in claim 41, wherein, in a split terminal scenario of a scheme for interworking a 3GPP authentication architecture and an OpenID authentication architecture, the first device comprises an Authentication Agent of the 3GPP/OpenID authentication architecture, the second device comprises an OpenID Provider and Network Application Function of the 3GPP/OpenID authentication architecture, and the third device comprises a Browsing Agent of the 3GPP/OpenID authentication architecture.

47. An apparatus as claimed in claim 41, wherein the token is representative rather than actual, and wherein the step of comparing the received token with the previously-sent token amounts to comparing what is represented by the received token with what is represented by the previously-sent token.

48. A program for controlling an apparatus to perform a method as claimed in claim 1, carried for example on a carrier medium such as a storage medium or a transmission medium.

49. A storage medium containing a program as claimed in claim 48.

50. A program for controlling an apparatus to perform a method as claimed in claim 29, carried for example on a carrier medium such as a storage medium or a transmission medium.

51. A storage medium containing a program as claimed in claim 50.
